(19) United States
(12) Patent Application Publication
(10) Pub. No.: US 2009/0267927 A1
(43) Pub. Date: Oct. 29, 2009

(54) DISPLAY APPARATUS AND METHOD FOR SUPPLYING POWER TO DISPLAY APPARATUS

(75) Inventor: Young-kyan YUN, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/235,673

(22) Filed: Sep. 23, 2008

(30) Foreign Application Priority Data
Apr. 25, 2008 (KR) 10-2008-0038867

(51) Int. Cl. G06F 3/038; G09G 5/00

(52) U.S. Cl. 345/211; 345/1.1

(57) ABSTRACT

A display apparatus and a method for supplying power thereto are provided. The display apparatus includes an interface which is connected to an external device and which receives image data and input power from the external device, a display unit which displays the received image data, and a control unit which operates the display unit using the input power received through the interface.

### CROSS-REFERENCE TO RELATED APPLICATIONS

This application claims priority from Korean Patent Application No. 10-2008-0038867, filed on Apr. 25, 2008 in the Korean Intellectual Property Office, the disclosure of which is incorporated herein by reference in its entirety.

### BACKGROUND OF THE INVENTION

1. Field of the Invention

Apparatuses and methods consistent with the present invention relate to a display apparatus and a method for supplying power thereto, and more particularly, to a display apparatus for dual monitors and a method for supplying power thereto.

2. Description of the Related Art

Dual monitor systems, in which two monitors are connected to a single computer, have recently become widespread. Since dual monitors have a wider screen are than a single monitor, users can use dual monitors in order to compare two documents on screen or use two services at the same time.

However, in order to use a dual monitor system, the user must install a graphics card which can support dual monitors, connect two monitors, and performs an appropriate set-up procedure. Such a process may be fairly difficult for computer beginners.

In addition, in order to use a dual monitor system, the user must purchase two monitors, and a graphics card which can support dual monitors, so considerable expense is required in order to use a dual monitor system.

Therefore, there is a demand for methods to provide the user with a dual monitor system more economically and conveniently.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

An aspect of the present invention provides a display apparatus which receives image data and power from an external device and is operated using the received power, and a method for supplying power to the display apparatus.

Another aspect of the present invention provides a display apparatus which receives image data from a host and transmits a certain portion of power supplied by an external power together with the received image data to an external display apparatus.

According to an exemplary aspect of the present invention, there is provided a display apparatus including an interface which is connected to an external device and receives image data and input power from the external device, a display unit which displays the received image data, and a control unit which operates the display unit using the input power received through the interface.

The external device may be an external display apparatus or a host.

The display apparatus may not receive separate external power, and is operated using only the input power received through the interface.

The display apparatus may further include a decoder which decodes the received image data to generate decoded image data, wherein the display unit displays images corresponding to the decoded image data.

The decoded image data may include a transistor-transistor logic (TTL) signal and vertical and horizontal sync signals, and the TTL signal and the vertical and horizontal sync signals may be input into the display unit.

The interface may be a universal serial bus (USB).

According to another exemplary aspect of the present invention, there is provided a method for supplying input power to a display apparatus having a display unit, the method including receiving image data and the input power from an external device through an interface, displaying the received image data, and operating the display unit using the received input power.

The external device may be an external display apparatus or a host.

In operating the display unit, the display may be operated using only the power received through the interface without receiving separate external power.

The method may further include decoding the image data received through the interface to generate decoded image data, and displaying images corresponding to the decoded image data.

The decoded image data may include a transistor-transistor logic (TTL) signal and vertical and horizontal sync signals, and the method may further include inputting the TTL signal and the vertical and horizontal sync signals to the display unit.

The interface may be a universal serial bus (USB).

According to another exemplary aspect of the present invention, there is provided a display apparatus including a power supply unit which receives external power, a first interface which is connected to a host and receives image data from the host, and a second interface which is connectable to an external display apparatus, and which transmits a portion of the external power received by the power supply unit and the received image data to the external display apparatus, if the second interface is connected to the external display apparatus.

The first interface and the second interface may be universal serial buses (USBs).

According to another exemplary aspect of the present invention, there is provided a method for supplying power to an external display apparatus, the method including receiving external power, receiving image data from the host through a first interface, and transmitting part of the received external power and the received image data to the external display apparatus through a second interface.

The first interface and the second interface may be universal serial buses (USBs).

According to another exemplary aspect of the present invention, there is provided a display apparatus connected to an external power source and a host, the display apparatus including a main display which receives the external power, and includes a first interface and a second interface, and a sub-display which includes a third interface to be which is connectable to the second interface, which receives image data and a portion of the external power from the second interface if the third interface is connected to the second interface, and which displays images corresponding to the image data by using the portion of the external power received by the third interface, wherein the first interface receives the image data from the host, and the second interface transmits the image data received through the first interface and the portion of the external power to the third interface.

The sub-display may further include a decoder which decodes the image data received through the third interface to generate decoded image data, and displays images corresponding to the decoded image data.

The decoded image data may include a transistor-transistor logic (TTL) signal and vertical and horizontal sync signals, and the sub-display may further include a panel driving unit which receives the TTL signal and the vertical and horizontal sync signals.

The first interface, the second interface, and the third interface may be universal serial buses (USBs).

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram illustrating connection of the components of a display apparatus according to an exemplary embodiment of the present invention;

FIG. 2 is a detailed block diagram illustrating a sub-display according to an exemplary embodiment of the present invention;

FIG. 3 is a flow chart of a method for supplying power to a display apparatus according to an exemplary embodiment of the present invention;

FIG. 4 is a schematic perspective view of the exterior of the display apparatus according to an exemplary embodiment of the present invention;

FIG. 5 is a rear view of the exterior of the display apparatus according to an exemplary embodiment of the present invention;

FIG. 6 illustrates a main display and a sub-display which are used together according to an exemplary embodiment of the present invention;

FIG. 7 is a block diagram of a display apparatus according to a second exemplary embodiment of the present invention;

FIG. 8 is a flow chart of a method for supplying power to a display apparatus according to a second exemplary embodiment of the present invention;

FIG. 9 is a block diagram of a display apparatus according to a third exemplary embodiment of the present invention;

FIG. 10 is a flow chart of a method for supplying power to a display apparatus according to a third exemplary embodiment of the present invention; and

FIG. 11 is a block diagram of a display apparatus according to a fourth exemplary embodiment of the present invention.

### DETAILED DESCRIPTION OF EXEMPLARY EMBODIMENTS OF THE INVENTION

Certain exemplary embodiments of the present invention will now be described in greater detail with reference to the accompanying drawings.

In the following description, like drawing reference numerals are used for like elements, even in different drawings. The matters defined in the description, such as the detailed construction and elements, are provided to assist in a comprehensive understanding of the invention. However, the present invention can be practiced without those specifically defined matters. Also, well-known functions or constructions are not described in detail since they would obscure the invention with unnecessary detail.

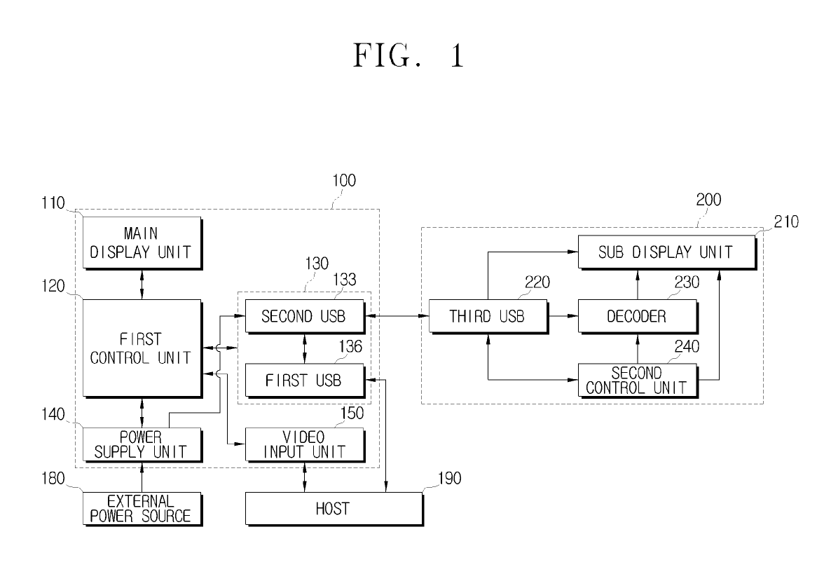

FIG. 1 is a block diagram illustrating connection of the components of a display apparatus according to an exemplary embodiment of the present invention. As illustrated in FIG. 1, the display apparatus includes a main display 100 and a sub-display 200. The main display 100 is connected to an external power source 180 and a host 190.

The main display 100 is electrically connected to the sub-display 200 via a universal serial bus (USB) cable. In addition, the main display 100 is physically connected to the sub-display 200 via a connection structure.

The main display 100 and the sub-display 200 function as dual monitors. In other words, a screen output by the single host 190 is displayed on the main display 100 and the sub-display 200, so the user can use a dual monitor function easily.

However, the main display 100 and the sub-display 200 can also function as independent display apparatuses.

The main display 100 includes a main display unit 110, a first control unit 120, a USB hub 130, a power supply unit 140, and a video input unit 150.

The main display unit 110 displays images corresponding to image data input from the host 190 through the video input unit 150. The main display unit 110 may include a liquid crystal display (LCD) panel, an LCD panel driving unit, a backlight, and a backlight driving unit. The main display unit 110 may also be implemented as a plasma display panel (PDP) instead of an LCD.

The first control unit 120 controls the overall operation of the main display 100. In particular, the first control unit 120 processes image data input through the video input unit 150, and transmits the processed image data to the main display unit 110.

The USB hub 130 includes a plurality of USB ports. In this exemplary embodiment, the USB hub 130 includes a first USB 136 and a second USB 133.

The first USB 136 is connected to the host 190 in order to receive image data. The first USB 136 and the second USB 133 are interconnected since they are provided in the USB hub 130.

More specifically, the first USB 136 receives image data which are converted to a USB standard by the host 190. The host 190 includes a driver which converts image data to a USB standard. The driver is generally implemented as a software driver, but may also be implemented as hardware driver. Consequently, the first USB 136 can receive image data from the host 190 according to a USB standard.

The second USB 133 is connected to a third USB 220 of the sub-display 200 in order to transmit image data received from the first USB 136 to the third USB 220 of the sub-display 200.

Furthermore, the second USB 133 transmits part of power supplied through the power supply unit 140 to the third USB 220 of the sub-display 200 so that sufficient power can be supplied to drive the sub-display 200.

In detail, it is assumed that an electric current approximately 850 mA is needed to drive the sub-display 200. However, generally, an electric current transmitted through a USB is approximately 500 mA, so an additional power supply is needed to drive the sub-display 200 connected through the USB.

Accordingly, by transmitting a certain portion of the power supplied by the power supply unit 140 to the second USB 133, the sub-display 200 can be driven without separately receiving external power.

More specifically, a USB port consists of a total of 4 lines, such as Vcc, D+, D−, and GND, in which Vcc and GND are lines to transmit power, and D+ and D− are lines to transmit data. Accordingly, if a power line of the power supply unit 140 is connected to the Vcc line of the second USB 133, the second USB 133 can transmit additional power. In other words, since the power line of the power supply unit 140 is connected to the USB hub 130, and the first USB 136 and the second USB 133 are connected to each other through the USB hub 130, the power in the power supply unit 140 can be transmitted to the second USB 133. As a result, an amount of electric current which can be transmitted through the second USB 133 can be increased.

The power supply unit 140 receives power from the external power source 180, and the power is transformed to an appropriate voltage by an adapter. The power supply unit 140 distributes the power to all the components of the main display 100. In particular, the power supply unit 140 transmits a portion of the power to the second USB 133.

The video input unit 150 is connected to the host 190 in order to receive image data output from a graphic card of the host 190. The image data have data formats such as red-green-blue (RGB), digital video interactive (DVI), or the like.

The external power source 180 supplies power to the main display 100, and can be implemented as a wall outlet.

The host 190 is connected to the video input unit 150 and the first USB 136 of the main display 100. The host 190 outputs image data to be displayed on the main display 100 to the video input unit 150, and also outputs image data to be displayed on the sub-display 200 to the first USB 136. The host 190 may be a desktop computer, a notebook computer, or a server computer.

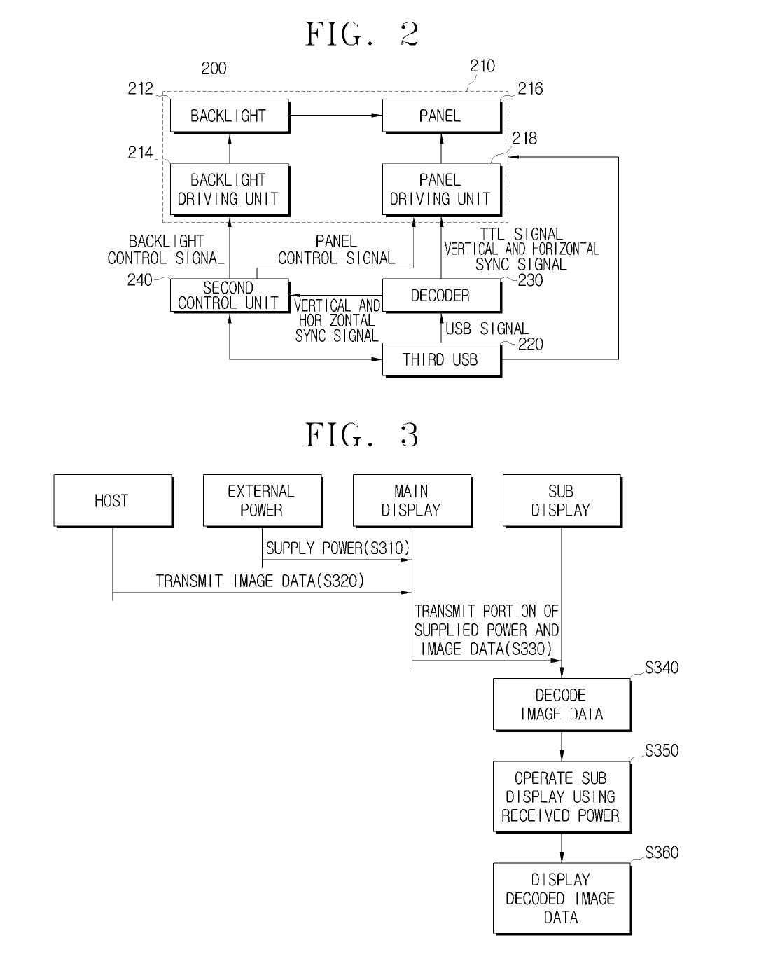

The sub-display 200 includes a sub-display unit 210, a third USB 220, a decoder 230, and a second control unit 240. The configuration of the sub-display 200 is described here in detail with reference to FIG. 2.

FIG. 2 is a detailed block diagram illustrating the sub-display apparatus 200 according to an exemplary embodiment of the present invention. As illustrated in FIG. 2, the sub-display 200 includes a sub-display unit 210, a third USB 220, a decoder 230, and a second control unit 240.

The sub-display unit 210 may include a backlight 212, a backlight driving unit 214, a panel 216, and a panel driving unit 218. In this exemplary embodiment, the sub-display 200 is assumed to be an LCD, but it may also be implemented as various other kinds of display, such as a plasma display panel (PDP).

The backlight 212 emits light using a driving current induced from the backlight driving unit 214, and irradiates the light to the panel 216. Generally, a plurality of cathode fluorescent lamps are used as lamps for the backlight 212. Cathode fluorescent lamps include cold cathode fluorescent lamps (CCFLs), hot cathode fluorescent lamps (HCFLs), and flat fluorescent lamps (FFLs).

The backlight driving unit 214 receives a backlight control signal (for example, a pulse width modulation (PWM) dimming voltage) from the second control unit 240, and thus the backlight driving unit 214 transmits a driving current corresponding to the backlight control signal to the backlight 212.

The panel 216 visualizes input image data by adjusting the transmittance of light emitted by the backlight 212 so that images can be displayed on the sub-display 200.

The panel driving unit 218 receives image data decoded by the decoder 230. The decoded image data includes TTL signals, and horizontal and vertical signals.

In addition, the panel driving unit 218 receives a panel control signal from the second control unit 240, and generates a driving current to drive the panel 216 using information regarding the luminance and color, which is included in the input image data, and the panel control signal, and transmits the generated driving current to the panel 216.

As described above, the sub-display unit 210 includes the backlight 212, the backlight driving unit 214, the panel 216, and the panel driving unit 218, and displays images corresponding to input image data.

The third USB 220 is connected to the second USB 133 of the main display 100 in order to receive image data and power. Accordingly, the third USB 220 transmits the received image data to the decoder 230, and supplies the power to the overall sub-display 200 in order to operate the sub-display 200. For example, if the third USB 220 transmits the received power to the second controller 240, the second controller 240 controls the sub-display unit 210 to be operated using the power.

The decoder 230 decodes the image data received through the third USB 220. The image data received through the third USB 220 are USB signals which are converted to a USB standard. Accordingly, the USB signals must be decoded in a signal format to drive the sub-display unit 210. Therefore, the decoder 230 decodes USB signals as transistor-transistor logic (TTL) signals and vertical and horizontal signals which are optimized to operate the sub-display unit 210.

Moreover, the decoder 230 outputs the decoded TTL signals and vertical and horizontal signals directly to the panel driving unit 218 of the sub-display unit 210. Therefore, the sub-display 200 inputs the TTL signals directly into the sub-display unit 210 without converting the TTL signals into TMDS signals and LVDS signals.

The second control unit 240 controls the overall operation of the sub-display 200, and distributes power supplied through the third USB 220 to all the components of the sub-display 200. More specifically, it is assumed that the second control unit 240 receives a voltage of 5V from the third USB 220. The second control unit 240 applies 5V to the sub-display unit 210 in order to operate the sub-display unit 210. Since the second control unit 240 operates at 3.3V, the second control unit 240 transforms the 5V into 3.3V.

The second control unit 240 generates a panel control signal and a backlight control signal corresponding to image data, and transmits the panel control signal to the panel driving unit 218 and the backlight control signal to the backlight driving unit 214.

Furthermore, the second control unit 240 controls the power supply to the backlight 212 of the sub-display unit 210 using vertical and horizontal sync signals. In greater detail, if the vertical and horizontal sync signals are ‘0,’ the second control unit 240 does not supply power to the backlight 212. This is because vertical and horizontal sync signals of ‘0’ represent a black screen, so the backlight 212 does not need to be operated. That is, if the vertical and horizontal sync signals are ‘0,’ power is not supplied to the backlight 212 and thus power consumption can be reduced.

Following the above process, the sub-display 200 can be operated using the power received from the main display 100 through the third USB 220 without receiving separate external power.

A process for operating the sub-display is described here with reference to FIG. 3, which is a flow chart of a method for supplying power to a display apparatus according to an exemplary embodiment of the present invention.

The main display 100 receives power from the external power source 180 (S310), and receives image data from the host 190 through the first USB 136 (S320).

Subsequently, the main display 100 transmits part of the received power and the received image data to the sub-display 200 (S330). The second USB 133 of the main display 100 is connected to the third USB 220 of the sub-display 200.

The sub-display 200 decodes the received image data (S340). The decoded image data includes TTL signals and vertical and horizontal sync signals.

The sub-display 200 is driven using the received power without receiving separate external power (S350), and displays images corresponding to the decoded image data (S360).

Through this process, the sub-display 200 can display images using power supplied from the main display 100.

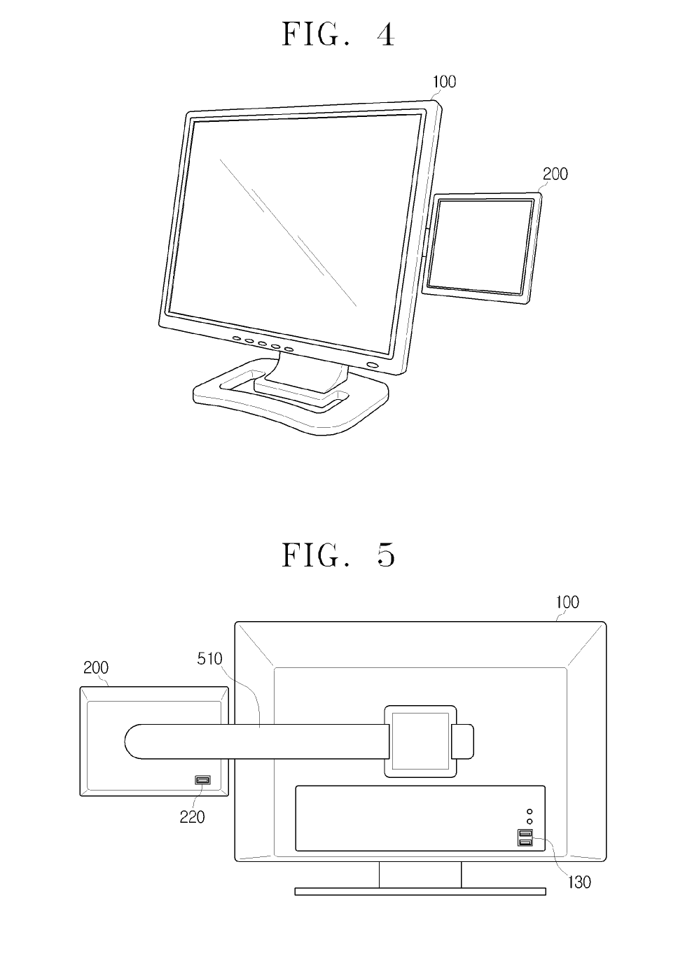

The exterior of a display apparatus according to an exemplary embodiment of the present invention is described here with reference to FIGS. 4 and 5. FIG. 4 is a schematic perspective view of the exterior of the display apparatus according to an exemplary embodiment of the present invention. As illustrated in FIG. 4, the display apparatus includes a main display 100 and a sub-display 200.

FIG. 5 is a rear view of the exterior of the display apparatus according to an exemplary embodiment of the present invention. As illustrated in FIG. 5, the main display 100 is connected to the sub-display 200 via a connection structure 510. The position of the sub-display 200 can be changed by moving the connection structure 510, and the sub-display 200 may be detached from the main display 100.

The USB hub 130 is disposed on the rear surface of the main display 100. The USB hub 130 includes two USBs which can be used as the first USB 136 and the second USB 133.

The sub-display 200 includes a single USB, which can be used as the third USB 220, on the rear surface thereof The sub-display 200 is not connected to a separate power source.

As described above, dual monitors having a main display 100 connected to a sub-display 200 can be provided.

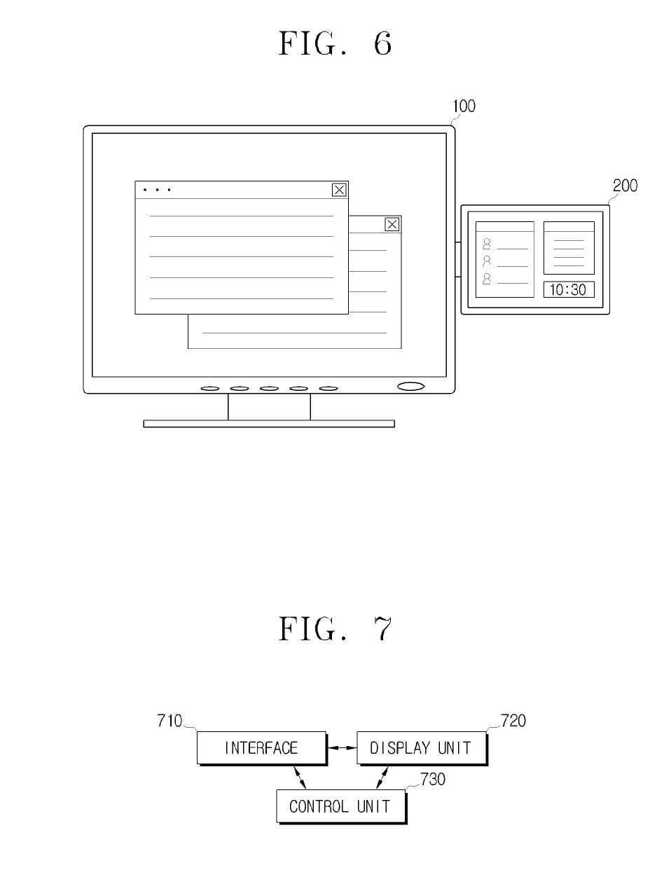

An example in which a display apparatus is used is described here. FIG. 6 illustrates a main display and a sub-display which are used together according to an exemplary embodiment of the present invention.

As illustrated in FIG. 6, the main display 100 and the sub-display 200 display different contents, so the user can use them as dual monitors.

In FIG. 6, the user can open and use important operation windows on the main display 100, and open and use auxiliary operation windows, such as a messenger or a clock, on the sub-display 200.

Using such a sub-display 200 which can be operated by connecting a USB to the main display 100 without supplying separate power, the user can utilize dual monitors more economically and conveniently.

In this exemplary embodiment, the sub-display 200 is connected to the main display 100, and can also be connected to any other devices having a USB. For example, the sub-display 200 may be connected directly to the host 190, such as a desktop computer, a notebook computer, or a server computer. In this case, the sub-display 200 receives power through the USB of the host 190. Therefore, the sub-display 20 can be operated using only power supplied through the USB without supplying separate external power to the sub-display 200.

In this exemplary embodiment, the interface is implemented as a USB, but any other kinds of interfaces which can transmit image data and power can be applied to the present invention.

Another exemplary embodiment of the present invention is described here with reference to FIGS. 7 to 11.

FIG. 7 is a block diagram of a display apparatus according to the second exemplary embodiment of the present invention. The display apparatus includes an interface 710, a display unit 720, and a control unit 730.

The interface 710 is connected directly to an external display apparatus in order to receive image data and power from the external display apparatus. The display unit 720 displays the received image data. The control unit 730 operates the display unit 720 using the power received through the interface 710.

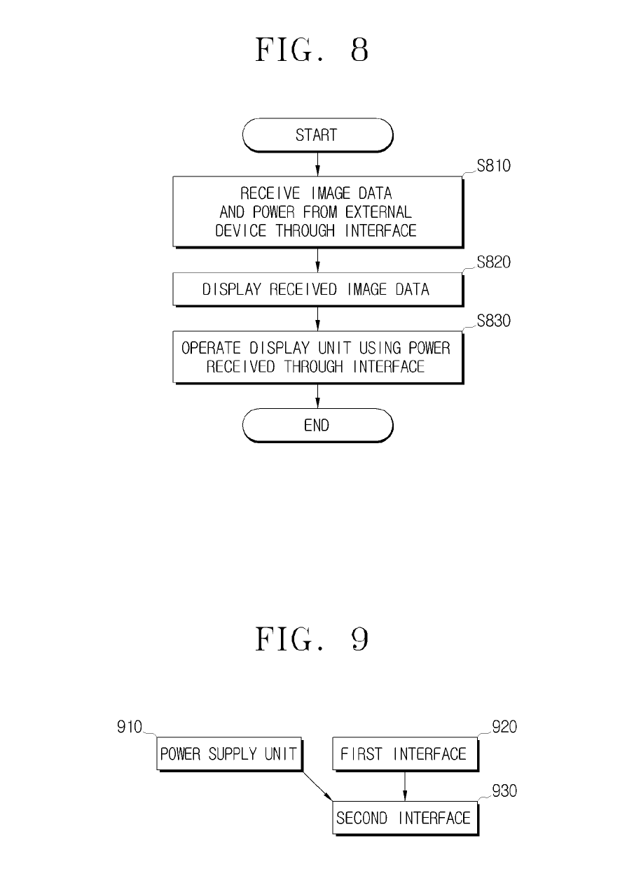

FIG. 8 is a flow chart of a method for supplying power to a display apparatus according to the second exemplary embodiment of the present invention.

As illustrated in FIG. 8, the display apparatus receives image data and power from the external display apparatus through the interface (S810). Subsequently, the display apparatus displays the received image data (S820) and operates the display unit using the power received through the interface (S830).

FIG. 9 is a block diagram of a display apparatus according to a third exemplary embodiment of the present invention. As illustrated in FIG. 9, the display apparatus includes a power supply unit 910, a first interface 920, and a second interface 930.

The power supply unit 910 receives external power. The first interface 920 is connected to a host in order to receive image data from the host. The second interface 930 is connected to an external display apparatus, and transmits a portion of the power supplied by the power supply unit 910 and the received image data to the external display apparatus.

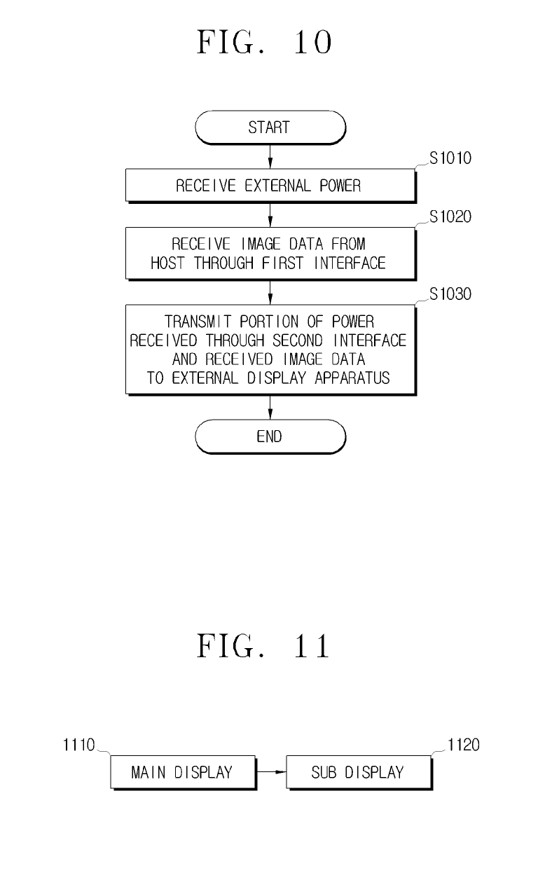

FIG. 10 is a flow chart of a method for supplying power to a display apparatus according to the third exemplary embodiment of the present invention.

The display apparatus receives external power (S1010), receives image data from the host through the first interface (S1020), and transmits a portion of the supplied power and the received image data to the external display apparatus through the second interface (S1030).

FIG. 11 is a block diagram of a display apparatus according to a fourth exemplary embodiment of the present invention. As illustrated in FIG. 11, the display apparatus includes a main display 1110 and a sub-display 1120.

The main display 1110 includes a first interface through which external power is supplied and image data are received from a host, and a second interface through which part of the supplied power and the received image data are transmitted to a third interface.

The sub-display 1120 includes the third interface which is connected directly to the second interface and which receives image data and power from the second interface, and displays images corresponding to the image data using the received power.

As described above, according to the exemplary embodiments of the present invention, a display apparatus which receives image data and power from an external display and is operated using the received power and a method for supplying power thereto are provided, so that the user can use dual monitors more economically and easily.

In particular, since the sub-display can be operated by only having a USB without separately having a power supply unit and an adapter, the cost of manufacturing the sub-display is reduced and thus the user can purchase the display apparatus with lower price.

Furthermore, since the sub-display is connected to the main display through the USB, the user can use dual monitors more easily.

The foregoing exemplary embodiments are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A display apparatus comprising:
an interface which is connected to an external device and receives image data and input power from the external device;
a display unit which displays the received image data; and
a control unit which operates the display unit using the input power received through the interface.

2. The display apparatus according to claim 1, wherein the external device is an external display apparatus or a host.

3. The display apparatus according to claim 1, wherein the display apparatus is operated using only the input powerreceived through the interface.

4. The display apparatus according to claim 1 further comprising:
a decoder which decodes the received image data to generate decoded image data,
wherein the display unit displays images corresponding to the decoded image data.

5. The display apparatus according to claim 4, wherein the decoded image data includes a transistor-transistor logic (TTL) signal and vertical and horizontal sync signals, and
wherein the TTL signal and the vertical and horizontal sync signals are input to the display unit.

6. The display apparatus according to claim 1, wherein the interface is a universal serial bus (USB).

7. A method for supplying input power to a display apparatus having a display unit, the method comprising:
receiving image data and the input power from an external device through an interface;
displaying the received image data; and
operating the display unit using the received input power.

8. The method according to claim 7, wherein the external device is an external display apparatus or a host.

9. The method according to claim 7, wherein the display unit is operated using only the input power received through the interface.

10. The method according to claim 7 further comprising:
decoding the image data received through the interface to generate decoded image data; and
displaying images corresponding to the decoded image data.

11. The method according to claim 10, wherein the decoded image data includes a transistor-transistor logic (TTL) signal and vertical and horizontal sync signals, and
wherein the method further comprises inputting the TTL signal and the vertical and horizontal sync signals to the display unit.

12. The method according to claim 7, wherein the interface is a universal serial bus (USB).

13. A display apparatus comprising:
a power supply unit which receives external power;
a first interface which is connected to a host and receives image data from the host; and
a second interface which is connectable to an external display apparatus, and which transmits a portion of the external power received by the power supply unit and the received image data to the external display apparatus, if the second interface is connected to the external display apparatus.

14. The display apparatus according to claim 13, wherein the first interface and the second interface are universal serial buses (USBs).

15. A method for supplying power to an external display apparatus, the method comprising:
receiving external power;
receiving image data from the host through a first interface; and
transmitting part of the received external power and the received image data to the external display apparatus through a second interface.

16. The method according to claim 15, wherein the first interface and the second interface are universal serial buses (USBs).

17. A display apparatus connected to an external power source and a host, the display apparatus comprising:
a main display which receives the external power, and includes a first interface and a second interface; and
a sub-display which includes a third interface which is connectable to the second interface, which receives image data and a portion of the external power from the second interface if the third interface is connected to the second interface, and which displays images corresponding to the image data by using the portion of the external power received by the third interface,
wherein the first interface receives the image data from the host, and the second interface transmits the image data received through the first interface and the portion of the external power to the third interface.

18. The display apparatus according to claim 17, wherein the sub-display further includes a decoder which decodes the image data received through the third interface to generate decoded image data, and displays images corresponding to the decoded image data.

19. The display apparatus according to claim 18, wherein the decoded image data includes a transistor-transistor (TTL) signal and vertical and horizontal sync signals, and
wherein the sub-display further includes a panel driving unit which receives the TTL signal and the vertical and horizontal sync signals.

20. The display apparatus according to claim 17, wherein the first interface, the second interface, and the third interface are universal serial buses (USBs).
